(19) United States
(12) Patent Application Publication
(10) Pub. No.: US 2011/0052195 A1
(43) Pub. Date: Mar. 3, 2011

(54) OPTICAL DATA COMMUNICATION USING OPTICAL DATA PATTERNS

(75) Inventor: Christopher Kent Karstens, Apex, NC (US)

(73) Assignee: International Business Machines Corporation, Armonk, NY (US)

(21) Appl. No.: 12/548,854

(22) Filed: Aug. 27, 2009

(51) Int. Cl. H04J 14/02; H04B 10/12

(52) U.S. Cl. 398/79; 398/200

(57) ABSTRACT

An optical data system and method for optically transmitting data. The system includes an optical transmitter. The optical transmitter includes a pattern mapper, a light source, and a light limiting device. The pattern mapper maps a data string to a pattern of light pulses. The pattern of light pulses corresponds to a two-dimensional array that is representative of the data string. The light source emits light toward a plurality of optical cables. The light limiting device is coupled to the pattern mapper and interposed between the light source and the optical cables. The light limiting device includes a plurality of light switches to selectively transmit the pattern of light pulses into the optical cables to form the light packet.

### BACKGROUND

The present invention relates to the field of optical communications and, more particularly, to improving fiber optic bandwidth using light-pattern based encoding.

A fiber optic can include a glass, plastic, or other fiber designed to guide light along its length. Light is generally kept in the core of an optical fiber, which is surrounded by a material called the cladding and which is designed to trap the light in the core using an optical technique referred to as total internal reflection. In other words, the optical fiber acts as a waveguide. Data can be encoded and conveyed over a fiber optical medium within an optical carrier wave. A digital bandwidth of a fiber optic is its data rate, which is often measured in bits/second. The greater the bandwidth, the more data can be carried across an optical fiber within a fixed period of time. At present, a typical bandwidth for a single color fiber optic medium is approximately 10 Gbit/s.

One bandwidth increasing technique specific to fiber optics is often referred to as wavelength division multiplexing (WDM). WDM is a technology that multiplexes multiple carrier signals on a signal optical fiber by using different wavelengths (e.g., colors) of laser light to carry different signals. In other words, WDM is a form of frequency division multiplexing (FDM) specific to optical carrier signals conveyed across fiber optic medium. WDM takes advantage of a fact that different frequencies of light travel along an optical fiber at different speeds and that multiple colors (i.e., wavelengths) can be concurrently conveyed along a single optical fiber in a non-disruptive fashion. That is, data encoded within one color does not disrupt or affect data encoded and conveyed within a different color. At present, when using WDM and three different colors (frequencies) of light concurrently, bandwidth along an optical fiber is effectively tripled. Modern WDM systems can utilize approximately 160 different non-conflicting frequencies concurrently. A bandwidth of a 160-color WDM fiber optic medium is approximately 160*10 Gbit/sec, which equals a total capacity of 1.6 Tbit/s over a single fiber optic medium.

Different variations of WDM include dense WDM (DWDM) and course WDM (CWDM). WDM, DWDM, and CWDM are based on the same concept of using multiple wavelengths of light on a single fiber, but differ from each other in the spacing of the wavelengths, the number of channels, and the ability to amplify the multiplexed signals in the optical space.

### SUMMARY

Embodiments of an apparatus are described. In one embodiment, the system is an optical transmitter to transmit a light packet. One embodiment of the optical transmitter includes a pattern mapper, a light source, and a light limiting device. The pattern mapper maps a data string to a pattern of light pulses. The pattern of light pulses corresponds to a two-dimensional array that is representative of the data string. The light source emits light toward a plurality of optical cables. The light limiting device is coupled to the pattern mapper and interposed between the light source and the optical cables. The light limiting device includes a plurality of light switches to selectively transmit the pattern of light pulses into the optical cables to form the light packet. Other embodiments of the apparatus are also described.

Embodiments of a system are also described. In one embodiment, the system is an optical data system. The system includes an optical transmitter and an optical receiver. The optical transmitter transmits a light packet over a plurality of optical cables. The light packet includes a plurality of light pulses mapped to a pattern within a two-dimensional array. The optical receiver receives the light packet sent over the plurality of optical cables. In an embodiment, the optical receiver includes a pattern lookup table, a pattern demapper, and an input/output (I/O) interface. The pattern lookup table stores a plurality of data pattern associations. Each data pattern association associates a pattern of light pulses to a string of data. The pattern demapper demaps the pattern of light pulses to the data string. The pattern demapper also queries the pattern lookup table in order to compare the received pattern of light pulses to a list of data pattern associations in the pattern lookup table. The pattern demapper also selects the data pattern association that matches the received pattern of light pulses. The input/output (I/O) interface outputs the data string from the optical receiver. Other embodiments of the system are also described.

Embodiments of a method are also described. In one embodiment, the method is a method for the transmission of optical data. The method includes storing a list of data pattern associations. Each data pattern association defines a unique two-dimensional pattern indicative of a relationship between a pattern of light pulses and a corresponding data string. The method also includes comparing a transmission data string with the list of data pattern associations. The method also includes selecting a two-dimensional pattern that matches the transmission data string. The method also includes emitting a beam of light. The method also includes optically switching at least a portion of the emitted beam of light through an array of light switches set according to the selected two-dimensional pattern. The method also includes transmitting a light packet over a plurality of optical cables optically coupled to the array of light switches. The light packet includes the pattern of light pulses mapped to the two-dimensional pattern. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE SEVERAL VIEWS OF THE DRAWINGS

FIG. 1 depicts a schematic diagram of one embodiment of an optical data system.

FIG. 2 depicts a schematic block diagram of one embodiment of an optical transmitter of the optical data system of FIG. 1 for use in association with the optical cables of FIG. 1.

FIG. 3 depicts a schematic diagram of one embodiment of an optical receiver of the optical data system of FIG. 1 for use in association with the optical cables of FIG. 1.

FIGS. 4A and 4B depict schematic block diagrams of one embodiment of data pattern associations stored in the pattern lookup tables of FIGS. 2 and 3.

FIG. 5 depicts a schematic flow chart diagram of one embodiment of an optical data pattern transmission method for use with the pattern demapper of FIG. 3.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated. The present invention may be embodied in other specific forms without departing from its spirit or essential characteristics. The described embodiments are to be considered in all respects only as illustrative and not restrictive. The scope of the invention is indicated, therefore, by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The illustrated embodiments described were chosen in order to best explain the principles of the invention and the practical application, and to enable others of ordinary skill in the art to understand the invention for various embodiments with various modifications as are suited to the particular use contemplated.

While many embodiments are described herein, at least some of the described embodiments facilitate an optical data system to project a light packet through a light limiting device such as a liquid crystal display (LCD). The light packet contains a specific pattern of light pulses arranged in a two-dimensional plane. The light packet projects onto a bundle of optical cables. The pattern contained in the light packet transmits across the cables where it is decoded on the receiving end. In one embodiment, the decoding end measures the intensity of each light pulse to determine whether the intensity exceeds a predetermined threshold.

An embodiment of the optical data system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Embodiments of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which executed via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

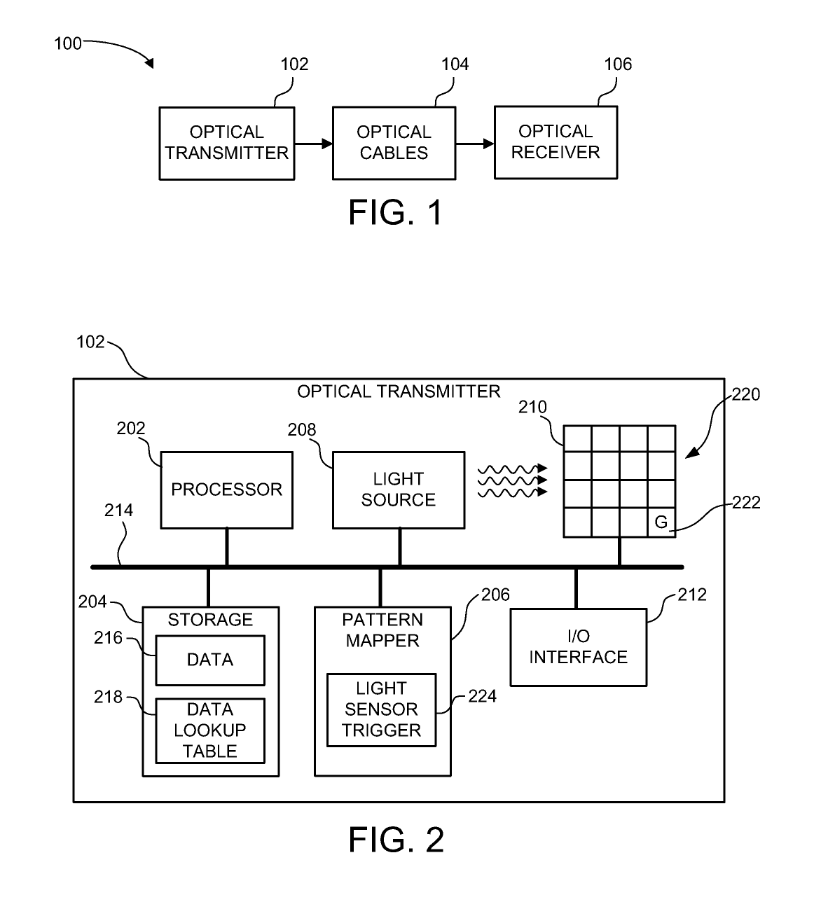

FIG. 1 depicts a schematic diagram of one embodiment of an optical data system 100. The optical data system 100 may interface a system user and an optical receiver 106 according to the interface operations of an optical transmitter 102. The illustrated optical data system 100 includes an optical transmitter 102, optical cables 104, and an optical receiver 106. Although the depicted optical data system 100 is shown and described herein with certain components and functionality, other embodiments of the optical data system 100 may be implemented with fewer or more components or with less or more functionality. For example, some embodiments of the optical data system 100 include a plurality of optical transmitters 102 and a plurality of optical receivers 106. Additionally, some embodiments of the optical data system 100 include similar components arranged in another manner to provide similar functionality, in one or more aspects.

The optical transmitter 102 manages the interface between the system user and the optical receiver 106. In one embodiment, the optical transmitter 102 is a desktop or laptop computer. In other embodiments, the optical transmitter 102 is a network module that allows a user to connect to and interact with an optical receiver 106. In some embodiments, the optical transmitter 102 is a component of an enterprise network. The optical transmitter 102 is connected to the optical receiver 106 via a bundle of optical cables or other type of optical cables 104.

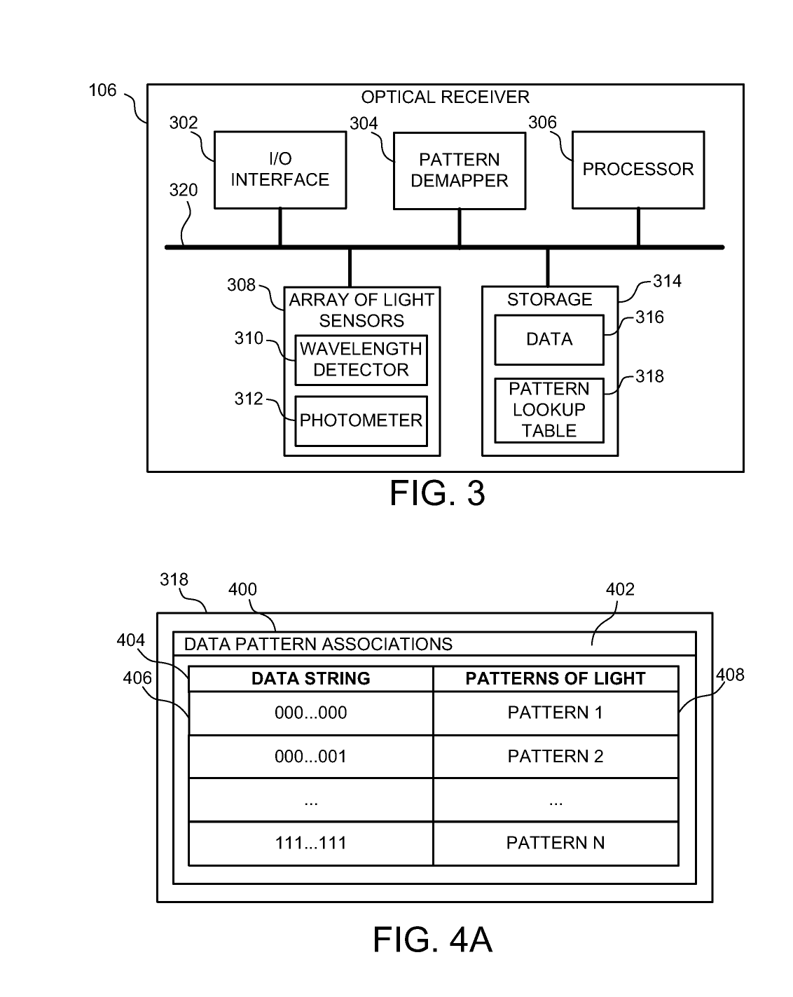

In one embodiment, the optical cables 104 are configured as a bundle of optical cables. The optical cables 104 interface with the optical transmitter 102 to guide a packet of light generated by the optical transmitter 102 along the length of optical cables 104. In one embodiment, the optical fibers 104 are arranged in a two-dimensional array of fiber optics. The optical cables 104 interface with the optical receiver 106 to send the packet of light to the optical receiver 106. The optical cables 104 may include glass, plastic, photonic-crystal, or other type of fiber. Embodiments of the optical cables 104 are described in further detail below in relation to FIGS. 2 and 3.

The optical receiver 106 manages the interface between the system user and the optical transmitter 104. In one embodiment, the optical receiver 106 is a desktop or laptop computer. In other embodiments, the optical receiver 106 is a network module that allows a user to connect to and interact with an optical transmitter 102. In some embodiments, the optical receiver 106 is a component of an enterprise network. The optical receiver 106 is connected to the optical transmitter 102 via a bundle of optical cables or other type of optical cables 104.

FIG. 2 depicts a schematic block diagram of one embodiment of an optical transmitter 102 of the optical data system 100 of FIG. 1 for use in association with the optical cables 104 of FIG. 1. The optical transmitter 102 transmits an optical form of data to the optical receiver 106. In one embodiment, the optical transmitter 102 transmits a light packet over the optical cables 104. The light packet includes a two-dimensional array of light pulses arranged in a particular two-dimensional pattern. The two-dimensional array of light pulses are simultaneously transmitted and carried over the optical cables 104. The illustrated example of an optical transmitter 102 includes a processor 202, a memory storage device 204, and a pattern mapper 206. The memory storage device 204 stores data 216 and a data lookup table 218. The pattern mapper 206 includes a light sensor trigger 224. The illustrated optical transmitter 102 also includes a light source 208, a light limiting device 210, and an I/O interface 212 to provide an optical connection to interface between the light limiting device 210 and the optical cables 104. The light limiting device 210 includes a two-dimensional array of light switches 220. Although the depicted optical transmitter 102 is shown and described herein with certain components and functionality, other embodiments of the optical transmitter 102 may be implemented with fewer or more components or with less or more functionality. For example, some embodiments of the optical transmitter 102 include a plurality of light sources 208 and a plurality of processors 202. Some embodiments of the optical transmitter 102 integrate the light source 208 with the light limiting device 210 such as an array of organic light emitting diodes (OLEDs). Additionally, some embodiments of the optical transmitter 102 include similar components arranged in another manner to provide similar functionality, in one or more aspects.

In one embodiment, the processor 202 is a central processing unit (CPU) with one or more processing cores. In other embodiments, the processor 202 is a graphical processing unit (GPU) or another type of processing device such as a general purpose processor, an application specific processor, a multi-core processor, or a microprocessor. Alternatively, a separate GPU may be coupled to the pattern mapper 206. In general, the processor 202 executes one or more instructions to provide operational functionality to the optical transmitter 102. The instructions may be stored locally in the processor 202 or in the memory storage device 204. Alternatively, the instructions may be distributed across one or more devices such as the processor 202, the memory storage device 204, or another data storage device. In one embodiment, the processor 202 facilitates the selection of a data pattern association that matches a string of data stored on the memory storage device 204. In some embodiments, the processor 202 processes a particular sequence of data contained in a selected data pattern association.

In some embodiments, the memory storage device 204 is a random access memory (RAM) or another type of dynamic storage device. In other embodiments, the memory storage device 204 is a read-only memory (ROM) or another type of static storage device. In other embodiments, the illustrated memory storage device 204 is representative of both RAM and static storage memory within a single optical data system 100. In other embodiments, the memory storage device 204 is an electronically programmable read-only memory (EPROM) or another type of storage device. Additionally, some embodiments store the instructions as firmware such as embedded foundation code, basic input/output system (BIOS) code, or other similar code. In one embodiment, the memory storage device 204 stores data that is optically transmitted from the optical transmitter 102 to the optical receiver 104. Additionally, some embodiments of the memory storage device 204 store a pattern lookup table 218. The data lookup table 218 includes a list of data pattern associations configured to associate a particular string of data to a particular two-dimensional pattern of light pulses. In one embodiment, the data lookup table 218 is indexed by data strings to find a pattern.

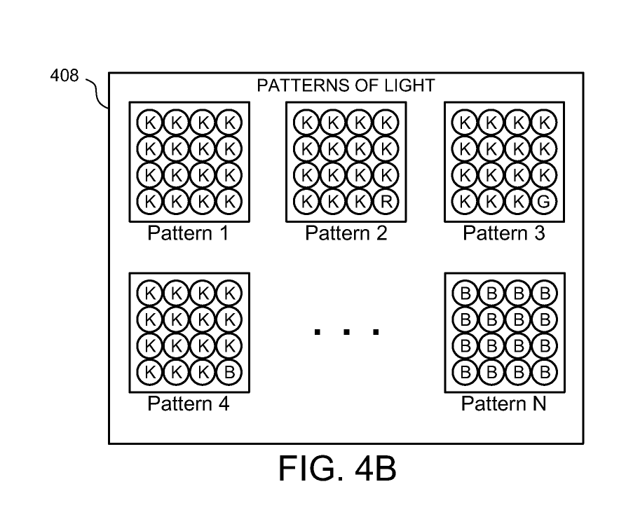

In one embodiment, the pattern mapper 206 maps a data string to a two-dimensional array of light pulses. The pattern mapper 206 queries the data lookup table 218 to compare the data string to a list of data pattern associations. The data string may be part of the data 216 stored on the memory storage device 204. The pattern mapper 206 selects a two-dimensional pattern corresponding to the data pattern association that matches the data string. The light sensor trigger 224 then sets the plurality of light switches in the light limiting device 210 according to the two-dimensional pattern. The light sensor trigger 224, in one embodiment, triggers the light source 208 to emit a beam of light. Embodiments of the data lookup table 218 and data pattern associations are described in further detail below in relation to FIGS. 4A and 4B.

In one embodiment, the light source 208 emits a beam of light. The beam of light is emitted towards the light limiting device 210. In some embodiments, the light source 208 includes at least one cold cathode fluorescent lamp. In some embodiments, the light source 208 includes at least one semiconductor light source such as a light emitting diode, a laser diode, a superluminescent diode, and/or an organic light emitting diode.

In one embodiment, the light limiting device 210 emits a light packet. The light packet includes a two-dimensional array of light pulses that corresponds to the two-dimensional pattern selected by the pattern mapper 206. The two-dimensional array of light pulses also corresponds to the two-dimensional array of light switches 220 of the light limiting device 210. The light limiting device 210 is placed in the way of the light beam emitted by the light source 208. The light beam shines upon the light limiting device 210 and the two-dimensional array of light switches 220 optically switch at least a portion of the light beam through the light limiting device 210. In some embodiments, each of the two-dimensional arrays of light switches 220 include at least one color filter 222. Each color filter 222 is configured to selectively pass at least one wavelength of light from the light beam and to reflect other wavelengths of light. In the illustrated example, there is a four-by-four array of sixteen light switches 220. One of the illustrated two-dimensional arrays of light switches 220 includes a green color filter 222, depicted by the letter “G” in the lower corner of the light limiting device 210. In one embodiment, the green color filter 222 passes green light through the light limiting device 210 while reflecting all other colors, or wavelengths of light, contained in the light beam. As explained above, some embodiments of the optical transmitter 102 integrate the light source 208 with the light limiting device 210 such as an array of OLEDs or a liquid crystal display (LCD).

Although the illustrated embodiment includes a four-by-four array of light switches 220, there may be fewer or more individual optical cables 104 than the number of light switches 220. In one embodiment, the number of optical cables 104 is equal to the number of light switches 220, so that each light switch 220 transmits light into a corresponding optical cable 104. In another embodiment, the number of optical cables 104 is fewer than the number of light switches 220, so that the light from multiple light switches 220 may be directed to a single optical cable 104. For example, one optical cable 104 may be aligned with two or more light switches 104. In this example, each of the light switches may transmit a different color of light (e.g., one transmits red and the other transmits green). In any case, the light transmitted by each of the light switches 220 into the same optical cable 220 should be distinguishable at the optical receiver 106.

Also, in some embodiments, the number of light switches 220 corresponding to each optical cable 104 may vary from one cable to the next. As one example, a bundle of optical cables 104 may include thirteen cables, of which five cables 104 are aligned with individual light switches 220 on a 1-to-1 basis, six cables 104 are aligned with multiple light switches 220 on a 3-to-1 basis, and two cables 104 are aligned with multiple light switches 220 on a 12-to-1 basis. This example would allow the thirteen optical cables to be aligned with 47 different light switches 220. Other embodiments may use other alignment ratios or configurations.

FIG. 3 depicts a schematic diagram of one embodiment of an optical receiver 106 of the optical data system 100 of FIG. 1 for use in association with the optical cables 104 of FIG. 1. The optical receiver 106 receives an optical form of data from the optical transmitter 102. In one embodiment, the optical receiver 106 receives a light packet over the optical cables 104. The illustrated example of an optical receiver 106 includes an I/O interface 302, a pattern demapper 304, and a processor 306. The illustrated optical receiver 106 also includes an array of light sensors 308 and a memory storage device 314. The array of light sensor 308 includes a wavelength detector 310 and a photometer 312. The memory storage device 314 stores data 316 and a pattern lookup table 318. In one embodiment, the receiver I/O interface 302 provides an optical connection to interface between the optical cables 104 and the array of light sensors 308. Additionally, in some embodiments, the receiver I/O interface 302 is configured to output a data string from the receiver.

Although the depicted optical transmitter 102 is shown and described herein with certain components and functionality, other embodiments of the optical receiver 106 may be implemented with fewer or more components or with less or more functionality. For example, some embodiments of the optical receiver 106 include a plurality of processors 306. Additionally, some embodiments of the optical receiver 106 include similar components arranged in another manner to provide similar functionality, in one or more aspects.

The illustrated optical receiver 106 of FIG. 3 includes many of the same or similar components as the optical transmitter 102 of FIG. 2. These components are configured to operate in substantially the same manner described above, except as noted below.

In one embodiment, the optical receiver 106 receives a light packet sent over the optical cables 104. As explained above, the light packet includes a two-dimensional array of light pulses arranged in a particular two-dimensional pattern.

The two-dimensional array of light pulses are transmitted and carried over the optical cables 104 and simultaneously received by the optical receiver 106.

In one embodiment, the pattern demapper 304 demaps the two-dimensional array of light pulses into a corresponding data string. The pattern demapper 304 queries a pattern lookup table 318 in order to compare the received pattern of light pulses to a list of data pattern associations contained in the pattern lookup table 318. The pattern demapper 304 selects the data pattern association that matches the received pattern of light pulses. In one embodiment, the pattern lookup table 318 is indexed by patterns to find a particular data string.

The array of light sensors 308, in one embodiment, detects the light pulses sent over the optical cables 104. In some embodiments, the wavelength detector 310 detects a wavelength of at least one of the light pulses contained in the light packet. The photometer, in some embodiments, detects a light intensity of at least one of the light pulses contained in the light packet. The light sensor 308 determines whether the detected light intensity of at least one of the light pulses of the light packet exceeds a predetermined light intensity threshold.

In one embodiment, one end of the optical cables 104 is optically connected to the transmitter I/O interface 212. The other end of the optical cables 104 is optically connected to the receiver I/O interface 302. One embodiment of the optical cables 104 aligns each strand of the optical cables 104 with at least one light switch of the two-dimensional array of light switches 220. Likewise, one embodiment of the optical cables 104 aligns each strand of the optical cables 104 with at least one sensor of the array of light sensors 308. In some embodiments, the optical cables 104 are arranged as a two-dimensional array of fiber optics.

FIGS. 4A and 4B depict schematic block diagrams of one embodiment of data pattern associations 400 stored in the pattern lookup tables 218 and 318 of FIGS. 2 and 3, respectively. In particular, FIG. 4A depicts the data pattern associations 400 stored in the pattern lookup table 318, while FIG. 4B depicts one example of light patterns. In some embodiments, the data pattern associations 400 stored in the pattern lookup table 318 are substantially similar to data pattern associations stored in the data lookup table 218. It should be noted that other embodiments of the data pattern associations 400 may be implemented with fewer or more fields in relation to a stored association.

The illustrated data pattern associations 400 include a title bar 402, a header row 404, data string columns 406, and patterns of light columns 408. The title bar 402 depicts a title of the data pattern associations 400. The header row 404 includes a data string column header and a patterns of light column header. In some embodiments, the header row 404 includes fewer or more columns. The first illustrated data row associates a data string of all zeros “000 . . . 000” with a “PATTERN 1.” The second illustrated data row associates a data string “000 . . . 001” (decimal “1”) with a “PATTERN 2.” The third illustrated data row shows a break in the data pattern associations 400 that is illustrated by an ellipsis in each column of data to convey a sequence of associations included in the data pattern associations 400 but not explicitly illustrated in FIG. 4A. The fourth illustrated data row associates a data string of all ones “111 . . . 111” with a “PATTERN N.” Hence, the pattern lookup table 318 stores associations between a data string and a particular two-dimensional pattern of light.

The illustrated patterns of light 408 depict the N patterns of light associated with the N data strings. This example of the patterns of light 408 also shows a break in the patterns of light 408 illustrated by an ellipsis between the last two illustrated patterns of light 408 to convey a sequence of patterns included in the patterns of light 408 but not explicitly illustrated in FIG. 4B. In the illustrated example, each pattern includes a four-by-four two-dimensional depiction of the light pulses that pass through the optical cables 104. Each circle represents one of the optical cables 104 arranged in a two-dimensional array. Each circle includes a letter that represents the color of light passing through that particular fiber optic cable. In this example, there are four possible colors that can be projected through each of the optical cables 104: “K” represents the color black, “R” represents the color red, “G” represents the color green, and “B” represents the color blue. The illustrated patterns depict the particular two-dimensional patterns associated with a particular string of data. The first pattern, “PATTERN 1,” associates a four-by-four grid of all black colors with the first data string of all zeros in FIG. 4A, and so on. Although the illustrated example depicts the optical cables 104 arranged in a square grid, it should be noted that some embodiments arrange the optical cables 104 in other two-dimensional shapes such as a hexagonal bundle of optical cables 104, and so forth. Similarly, some embodiments include less or more optical cables 104 and implement less or more colors than the four depicted colors. Additionally, some embodiments implement several shades of a single color to create each of the patterns of light 408.

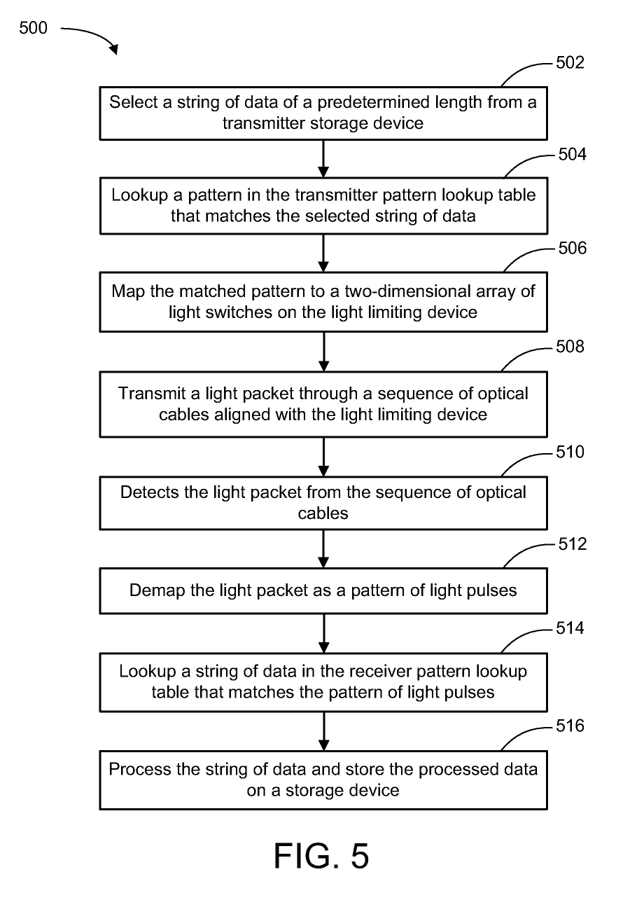

FIG. 5 depicts a schematic flow chart diagram of one embodiment of an optical data pattern transmission method 500 for use with the pattern demapper 304 of FIG. 3. For ease of explanation, the method 500 is described with reference to the demapper 304 of FIG. 3. However, some embodiments of the method 500 may be implemented with other demappers. Additionally, the method 500 is described in conjunction with the pattern lookup table 318, but some embodiments of the method 500 may be implemented with other lookup tables such as the data lookup table 218.

In the illustrated method 500, the pattern mapper 206 selects 502 a string of data of a predetermined length from the transmitter memory storage device 204. The pattern mapper 206 performs a lookup 504 of a pattern in the data lookup table 218 that matches the selected string of data. The pattern mapper 206 maps 506 the matched pattern to a two-dimensional array of light switches 220 on the light limiting device 210. The light limiting device 210 transmits 508 a light packet through the optical cables 104 aligned with the light limiting device 210. The light packet contains a specific pattern of light pulses arranged in a two-dimensional plane. The light packet projects through the optical cables 104 to the optical receiver 106. The array of light sensors 308 detects 510 the light packet received from the optical cables 104. The pattern demapper 304 demaps 512 the light packet as a pattern of light pulses. The pattern demapper 304 performs a lookup 514 of a string of data in the pattern lookup table 318 that matches the pattern of light pulses. The processor 306 processes 516 the string of data and stores the processed data as data 316 on a storage device such as the receiver memory storage device 314. The depicted method 500 then ends.

It should also be noted that at least some of the operations for the methods and operations described may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to compare a data string to a list of data pattern associations stored in a pattern lookup table. The operations also include an operation to select a two-dimensional pattern corresponding to the data pattern association that matches the data string, to set a plurality of light switches in a light limiting device according to the selected two-dimensional pattern, and to trigger a light source to emit a beam of light. The operations also include an operation to control optically switching at least a portion of the emitted beam of light through the array of light switches set according to the selected two-dimensional pattern and to control the transmission of a light packet over a plurality of optical cables optically connected to the plurality of light switches. The light packet includes a two-dimensional array of light pulses arranged according to the selected two-dimensional pattern.

The present invention may be at least partially embodied as a method, system, or computer program product. Accordingly, the present invention may take the form of an entirely hardware embodiment or an embodiment combining software (e.g., firmware, resident software, micro-code, etc.) and hardware aspects that may all generally be referred to herein as a “circuit,” “module” or “system.” Furthermore, the present invention may take the form of a computer program product on a computer-usable storage medium having computer-usable program code embodied in the medium. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk—read only memory (CD-ROM), compact disk—read/write (CDR/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave. In some embodiments, the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An optical transmitter to transmit a light packet, the optical transmitter comprising:
a pattern mapper to map a data string to a pattern of light pulses, wherein the pattern of light pulses corresponds to a two-dimensional array that is representative of the data string;
a light source to emit light toward a plurality of optical cables; and
a light limiting device coupled to the pattern mapper and interposed between the light source and the optical cables, the light limiting device comprising a plurality of light switches to selectively transmit the pattern of light pulses into the optical cables to form the light packet.

2. The optical transmitter of claim 1, further comprising a memory storage device to store a data lookup table which includes a list of data pattern associations indicative of relationships between a plurality of data strings and a corresponding plurality of two-dimensional patterns, wherein the pattern mapper is configured to query the data lookup table to compare the data string with the data pattern associations and to select the two-dimensional pattern identified in the data pattern association that matches the data string.

3. The optical transmitter of claim 2, wherein the data pattern associations comprise a plurality of polychromatic color combinations arranged in unique two-dimensional patterns, wherein each unique two-dimensional pattern is associated with a unique data string.

4. The optical transmitter of claim 3, wherein each of the light switches comprises a color filter, wherein each color filter is configured to selectively pass a wavelength of light from the light source to the optical cables according to a control signal from the pattern mapper.

5. The optical transmitter of claim 1, wherein the light source comprises at least one cold cathode fluorescent lamp, and the light emitting device comprises a liquid crystal display.

6. The optical transmitter of claim 1, wherein the light source comprises at least one semiconductor light source selected from the group consisting of a light emitting diode, a laser diode, a superluminescent diode, and an organic light emitting diode.

7. The optical transmitter of claim 1, further comprising a processor coupled to the pattern mapper, wherein the processor facilitates selection of the data pattern association that matches the data string.

8. A data system comprising:
an optical transmitter to transmit a light packet over a plurality of optical cables, wherein the light packet comprises a plurality of light pulses mapped to a pattern within a two-dimensional array; and
an optical receiver to receive the light packet sent over the plurality of optical cables, wherein the optical receiver comprises:
a pattern lookup table to store a plurality of data pattern associations, wherein each data pattern association is configured to associate a pattern of light pulses to a string of data;
a pattern demapper to demap the pattern of light pulses to the data string, wherein the pattern demapper is configured to query the pattern lookup table in order to compare the received pattern of light pulses to a list of data pattern associations in the pattern lookup table, and to select the data pattern association that matches the received pattern of light pulses; and
an input/output (I/O) interface to output the data string from the optical receiver.

9. The data system of claim 8, wherein the optical receiver further comprises a plurality of light sensors optically coupled to the plurality of optical cables, the plurality of light sensors to detect the light pulses sent over the plurality of optical cables.

10. The data system of claim 9, wherein each light sensor comprises a wavelength detector, the wavelength detector to detect a wavelength of a corresponding light pulse of the light packet and to distinguish among a plurality of wavelengths.

11. The data system of claim 9, wherein the light sensor further comprises a photometer, the photometer to detect a light intensity of a corresponding light pulse of the light packet, wherein the light sensor is further configured to determine whether the detected light intensity of at least one of the light pulses of the light packet exceeds a predetermined light intensity threshold.

12. The data system of claim 9, wherein one of the plurality of optical cables is configured to align with one of the plurality of light sensors.

13. The data system of claim 8, wherein the optical receiver further comprises a memory storage device, the memory storage device to store the pattern lookup table.

14. The data system of claim 13, wherein the optical receiver further comprises a processor, the processor to facilitate the selection of the data pattern association that matches the received pattern of light pulses to the data string and to output the particular sequence of data contained in the selected data pattern association.

15. A method comprising:
storing a list of data pattern associations, wherein each data pattern association defines a unique two-dimensional pattern indicative of a relationship between a pattern of light pulses and a corresponding data string;
comparing a transmission data string with the list of data pattern associations;
selecting a two-dimensional pattern that matches the transmission data string;
emitting a beam of light;
optically switching at least a portion of the emitted beam of light through an array of light switches set according to the selected two-dimensional pattern; and
transmitting a light packet over a plurality of optical cables optically coupled to the array of light switches, wherein the light packet comprises a plurality of light pulses mapped to the two-dimensional pattern.

16. The method of claim 15, further comprising:
receiving the light packet over the plurality of optical cables:
querying a pattern lookup table in order to compare the received pattern of light pulses to a replicated list of data pattern associations in the pattern lookup table, and
selecting the data pattern association that matches the received pattern of light pulses.

17. The method of claim 16, further comprising:
storing the list of data pattern associations in a data lookup table on a transmitter memory device; and
storing the replicated list of data pattern associations in the pattern lookup table on a receiver memory device.

18. The method of claim 15, further comprising detecting a wavelength of at least one of the light pulses contained in the light packet.

19. The method of claim 15, further comprising:
detecting a light intensity of at least one of the light pulses contained in the light packet; and
determining whether the detected light intensity exceeds a predetermined light intensity threshold.

20. The method of claim 15, further comprising selectively passing at least one wavelength of light from the beam of light and reflecting other wavelengths of light in the beam of light.
